(19) United States
(12) Patent Application Publication
(10) Pub. No.: US 2024/0282153 A1
(43) Pub. Date: Aug. 22, 2024

(54) SYSTEMS AND METHODS FOR DETECTING MACHINES ENGAGED IN ANOMALOUS ACTIVITY

(71) Applicant: Caterpillar Inc., Peoria, IL (US)

(72) Inventors: Kyle J. Cline, Savoy, IL (US); Prashant Rai, Fremont, CA (US)

(21) Appl. No.: 18/172,183

(22) Filed: Feb. 21, 2023

(51) Int. Cl. G07C 5/08; G07C 5/00

(52) U.S. Cl. CPC G07C 5/0808; G07C 5/008

(57) ABSTRACT

A method for detecting machines engaged in anomalous activity can include receiving telematics data from a plurality of sensors on each of a plurality of machines and determining one or more activity types for each machine over a series of activity time periods based on the associated telematics data for each machine. The method can also include calculating a proportion of the activity time periods in which each machine was engaged in one or more selected activities. The method further includes extracting one or more features for each machine for each of the series of activity time periods from the associated telematics data for each machine. One or more of the plurality of machines engaged in anomalous activity can be identified based on at least the proportion and the one or more extracted features for the machines.

### TECHNICAL FIELD

This patent application is directed to analyzing and identifying machine activity, and more specifically, to detecting machines engaged in anomalous activity.

### BACKGROUND

It is not unusual for equipment, such as an excavator, to be used for activities that the machine was not necessarily designed to perform. In some cases, the activity can be very hard on the excavator and cause premature wear or breakage of various components depending on the activity. This premature wear and breakage can have implications for warranty claims and customer satisfaction. For example, if a user has found a way to use an excavator to perform a task, albeit not within the design parameters of the machine, and the excavator experiences breakdowns the user may become frustrated.

U.S. Patent Application Publication No. 2012/0041575 to Maeda et al., (hereinafter “Maeda”) is directed to anomaly detection for early detection of an anomaly of a plant or a facility. While Maeda discloses improved methods for identifying anomalies in time-series signals (e.g., sensors) using compact learning data, Maeda is not directed to identifying unseen or anomalous machine usage. Thus, there is still a need to identify when machines are being used for activities that the machines were not designed to perform. The systems and methods described herein are directed to overcoming one or more of the deficiencies described above and/or other problems with the prior art.

### SUMMARY

In some embodiments, a method for detecting machines engaged in anomalous activity can include receiving telematics data from a plurality of sensors on each of a plurality of machines and determining one or more activity types for each machine over a series of activity time periods based on the associated telematics data for each machine. The method can also include calculating a proportion of the activity time periods in which each machine was engaged in one or more selected activities. The method further includes extracting one or more features for each machine for each of the series of activity time periods from the associated telematics data for each machine. One or more of the plurality of machines engaged in anomalous activity can be identified based on at least the proportion and the one or more extracted features for the machines.

In some aspects, the one or more selected activities includes digging and scrapping. In further aspects, the one or more features includes a maximum hydraulic pressure for one or more cylinders on the machine. In some aspects of the technology, identifying the one or more of the plurality of machines engaged in anomalous activity includes analyzing the proportion and the one or more extracted features using principal component analysis to identify outlier activity time periods for each machine. In still further aspects, identifying one or more of the plurality of machines engaged in anomalous activity includes identifying machines that have a percentage of outlier days exceeding a selected threshold. In some aspects, the method can further comprise for each machine identified as engaged in anomalous activity, calculating a difference between a mean value of each feature and a mean value of that feature for non-anomalous machines, selecting the two top features with the highest relative difference, and grouping the machines with the same two top features. In some aspects, each of the series of activity time periods is a day.

In some embodiments, a system for detecting machines engaged in anomalous activity can include one or more processors and one or more memory devices having instructions stored thereon. When executed, the instructions cause the processors to receive telematics data from a plurality of sensors on each of a plurality of machines and determine one or more activity types for each machine over a series of activity time periods based on the associated telematics data for each machine. The processors can also calculate a proportion of the activity time periods in which each machine was engaged in one or more selected activities. The processors also extract one or more features for each machine for each of the series of activity time periods from the associated telematics data for each machine. One or more of the plurality of machines engaged in anomalous activity can be identified based on at least the proportion and the one or more extracted features for the machines.

In some embodiments, one or more non-transitory computer-readable media can store computer-executable instructions that, when executed by one or more processors, cause the one or more processors to perform operations. The operations can include receiving telematics data from a plurality of sensors on each of a plurality of machines and determining one or more activity types for each machine over a series of activity time periods based on the associated telematics data for each machine. The operations also include calculating a proportion of the activity time periods in which each machine was engaged in one or more selected activities. The operations can further include extracting one or more features for each machine for each of the series of activity time periods from the associated telematics data for each machine. One or more of the plurality of machines engaged in anomalous activity can be identified based on at least the proportion and the one or more extracted features for the machines.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 is a diagram illustrating an overview of an environment in which some implementations can operate according to embodiments of the disclosed technology;

FIG. 2 is a block diagram illustrating an overview of an anomalous activity detection system according to some embodiments of the disclosed technology;

FIG. 3 is a diagram depicting using principal component analysis to identify outlier activity according to embodiments of the disclosed technology;

FIG. 4A is a chart illustrating the proportion of outlier days for various machines according to some embodiments of the disclosed technology;

FIG. 4B is a chart illustrating the probability of anomalous activity of various machines according to some embodiments of the disclosed technology;

FIG. 5 is a table illustrating the grouping of anomalous machines having the same features according to some embodiments of the disclosed technology;

FIG. 6 is a flow diagram showing a method for detecting machines engaged in anomalous activity according to some embodiments of the disclosed technology;

FIG. 7 is a block diagram illustrating an overview of devices on which some implementations can operate;

FIG. 8 is a block diagram illustrating an overview of an environment in which some implementations can operate; and

FIG. 9 is a block diagram illustrating components which, in some implementations, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all suitable modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed are methods and systems for detecting machines engaged in anomalous activity e.g., equipment, such as an excavator, being used for activities that the machine was not necessarily designed to perform. In some cases, the anomalous activities can be very hard on a machine and cause premature wear or breakage of various components depending on the activity. This premature wear and breakage can have implications for warranty claims and customer satisfaction. In addition, identifying anomalous activities can identify opportunities to enhance a machine's design and/or develop new attachments that may be better suited to the activity.

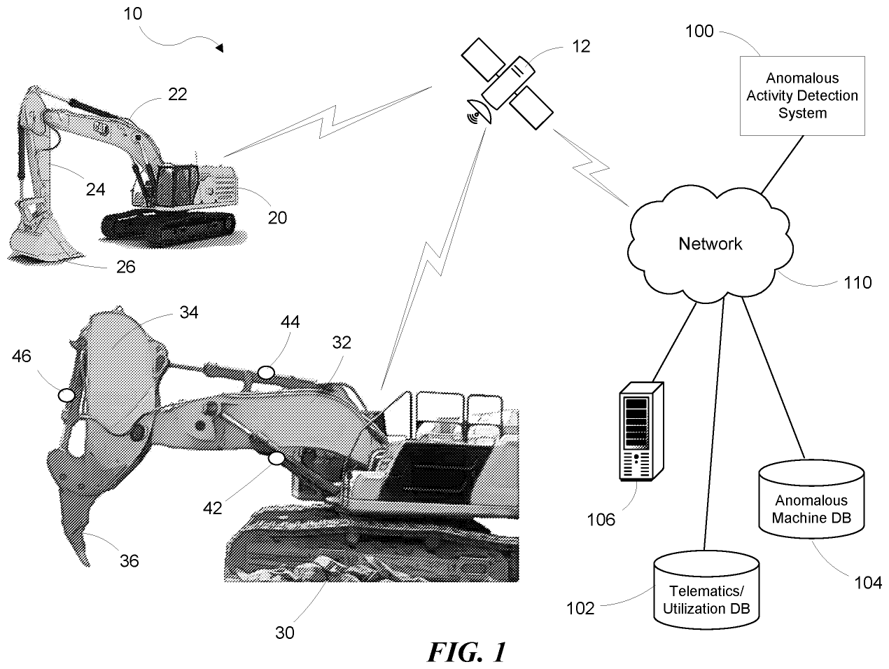

FIG. 1 illustrates an environment 10 in which some implementations of the anomalous activity detection system 100 can operate according to embodiments of the disclosed technology. As noted above, it is not unusual for equipment to be used for activities that a machine was not necessarily designed to perform. For example, customers have been known to replace an excavator bucket with a ripper attachment. A conventional excavator, such as excavator 20, includes a boom 22, a stick 24, and a bucket 26. Excavator 30 has been modified by replacing not only the bucket, but the boom and stick as well. The bucket has been replaced with a ripper attachment 36 and the boom has been replaced with a shortened boom 32. The stick has been replaced with a much shorter arm 34 and the relative pivot points for each component have changed. It should be noted that excavator 30 has been significantly modified for ripping material, yet the conventional sensor inputs, e.g., boom cylinder pressure 42, stick cylinder pressure 44, and bucket cylinder pressure 46, are maintained. Thus, an anomalous activity may not be detected simply by noting that one or more of the sensor inputs is missing. Furthermore, excavator 30 is only an example of a machine being used for anomalous activities. There are other anomalous activities where a machine is not necessarily modified, but used in an unconventional manner that can stress components in ways they were not necessarily designed to withstand.

The system environment 10 can include multiple machines, such as excavator 20 and modified excavator 30, a satellite 12, telematics/utilization database 102, an anomalous machine database 104, a telematics processing system 106, and a network 110. The anomalous activity detection system 100 can be connected to the telematics/utilization database 102, the anomalous machine database 104, and the telematics processing system 106 via network 110. The telematics/utilization database 102 and the telematics processing system 106 can receive telematics data from the excavators 20 and 30 via satellite 12. Cell radio, wifi, Bluetooth®, etc. are additional examples of suitable data transmission modes. The telematics data can include events, diagnostics, and sensor data from the excavators, such as from the boom cylinder pressure sensor 42, stick cylinder pressure sensor 44, and bucket cylinder pressure sensor 46, to name a few.

In some embodiments, the telematics processing system 106 determines a machine utilization pattern for the machines based on the telematics data. For example, a machine learning model (such as a neural network) can be applied to estimate each machine's utilization pattern based on telematics data (i.e., telemetry data). As an example, an excavator can have a use pattern of activities including 50% mass excavation, 20% grading, and 30% tracking (i.e., traveling from place to place).

In some embodiments, a utilization model can use mathematical models that classify equipment activity or application frequencies, which can include regression, support vector machines, and neural nets, depending on the level of detail and complexity required. These models may differentiate between, for example, mass excavation, dirt moving, trenching, scraping, digging, grading, loading, tracking, or idle time. Models may supplement standard telematics data with additional sensors to measure the intensity of use. In some embodiments, the resulting machine utilization patterns, or activity data, can be provided to the anomalous activity detection system 100.

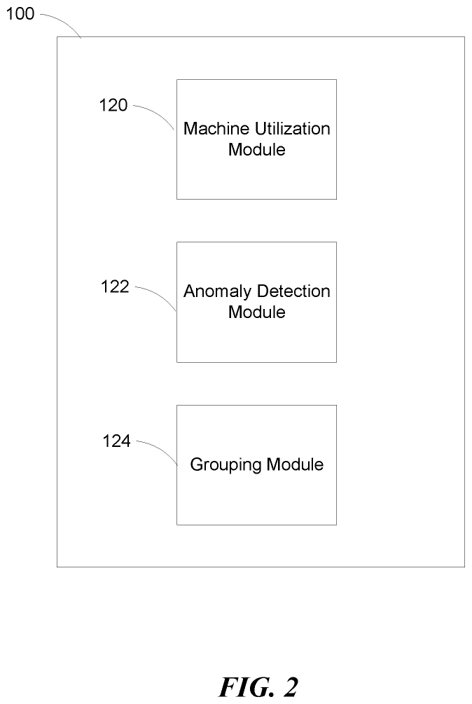

As shown in FIG. 2, the anomalous activity detection system 100 can comprise a Machine Utilization module 120, an Anomaly Detection module 122, and a Grouping module 124. In some embodiments, the Machine Utilization module 120 receives data from the Telematics/Utilization database 102 and/or telematics data from the sensors on the excavators, such as from the boom cylinder pressure sensor 42, stick cylinder pressure sensor 44, and bucket cylinder pressure sensor 46. In some embodiments, the Machine Utilization module 120 can apply a machine learning model to estimate each machine's utilization pattern based on the telematics data. Module 120 can also calculate a proportion of the activity time periods (e.g., days) in which each machine was engaged in one or more selected activities, such as digging and scraping. It should be noted that while the Machine Utilization module 120 can determine how a machine is being used for known applications, anomalous activity may not be differentiated from other known activities with a similar severity. For example, machines using a ripper attachment may be assigned a utilization pattern suggesting digging and scraping activities as the closest match.

In some embodiments, the Anomaly Detection module 122 is configured to extract one or more features, e.g., maximum cylinder pressure, for each machine for each of the series of activity time periods from the associated telematics data. Machines engaged in anomalous activity can be identified based on at least the proportion of days in which each machine was engaged in e.g., digging and scraping and the one or more extracted features for the machines. In some embodiments, the Anomaly Detection module 122 identifies the machines engaged in anomalous activity by analyzing the proportion and the one or more extracted features using principal component analysis to identify outlier days for each machine and identifying machines that have a percentage of outlier days exceeding a selected threshold (e.g., 60 percent).

In some embodiments, the Grouping module 124 can be configured to calculate a difference between a mean value of each feature and a mean value of that feature for non-anomalous machines. The two top features with the highest relative difference are selected and machines having the same top two features are grouped together. This grouping can facilitate an analysis of anomalous machines that might be in the same geographic region or owned by the same operator, for example.

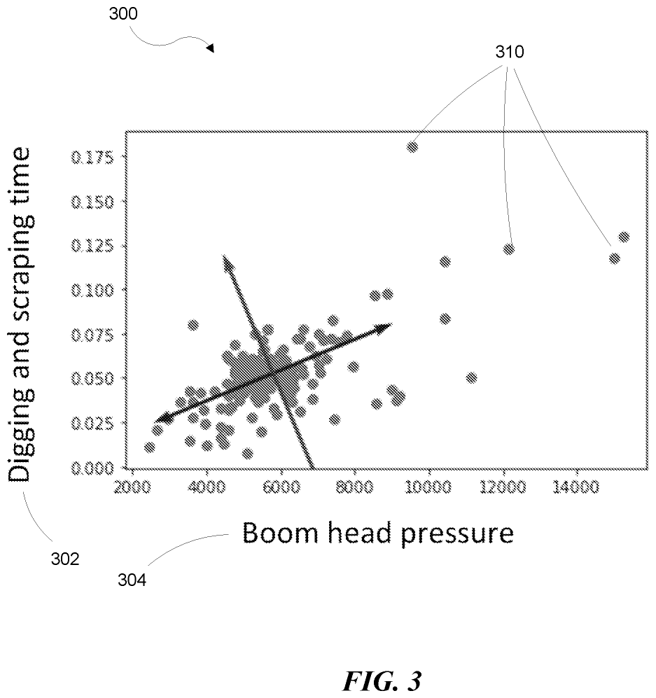

FIG. 3 is a graph 300 illustrating a representative principal component analysis of the proportion of digging and scraping time 302 versus a feature, e.g., boom head pressure 304, for multiple machines in order to identify outlier days 310. Each point represents a machine on a given day.

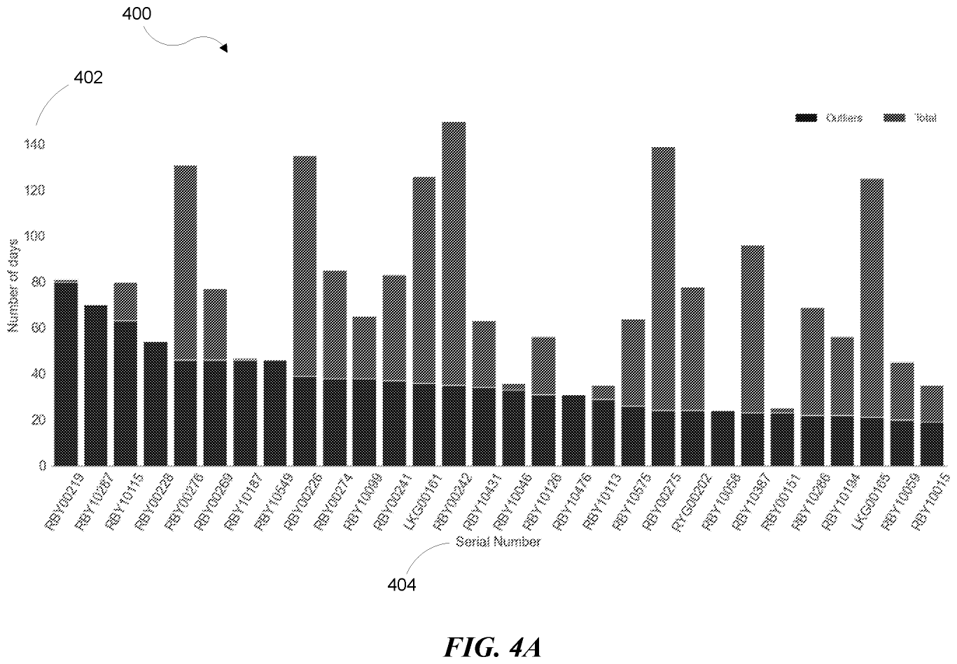

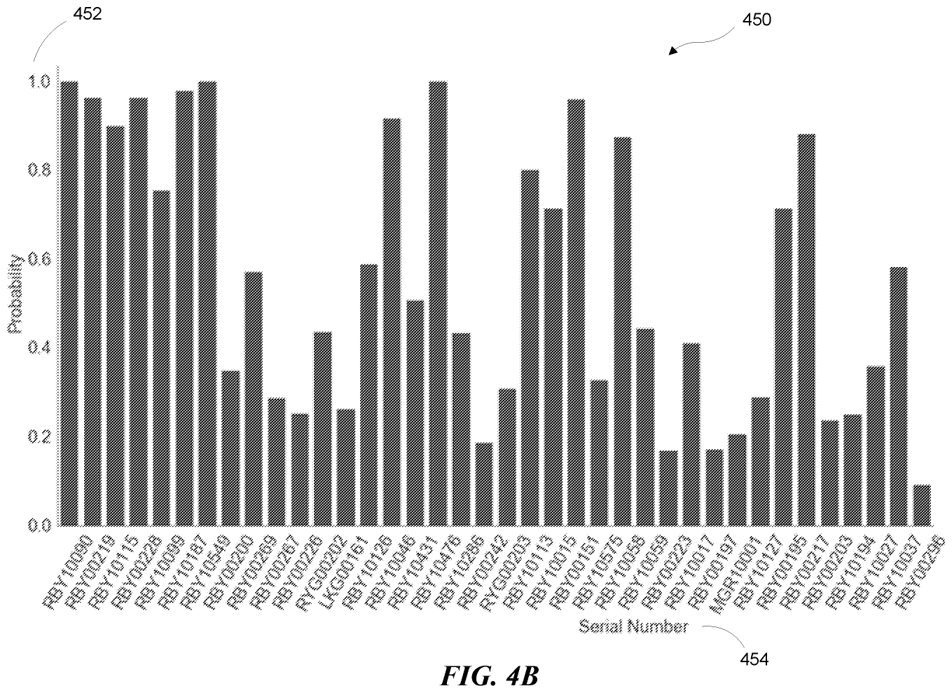

FIG. 4A is a chart 400 illustrating the proportion of outlier days identified from graph 300 against total days 402 for various machines by serial number 404. FIG. 4B is a chart 450 illustrating the probability 452 of anomalous activity of various machines by serial number 454. In some embodiments, the probability 452 can be calculated as the percent of total days that are identified as outlier days as shown in chart 400, for example. In some embodiments, machines are identified as being engaged in anomalous activity when the probability 452 exceeds a selected threshold (e.g., 60 percent).

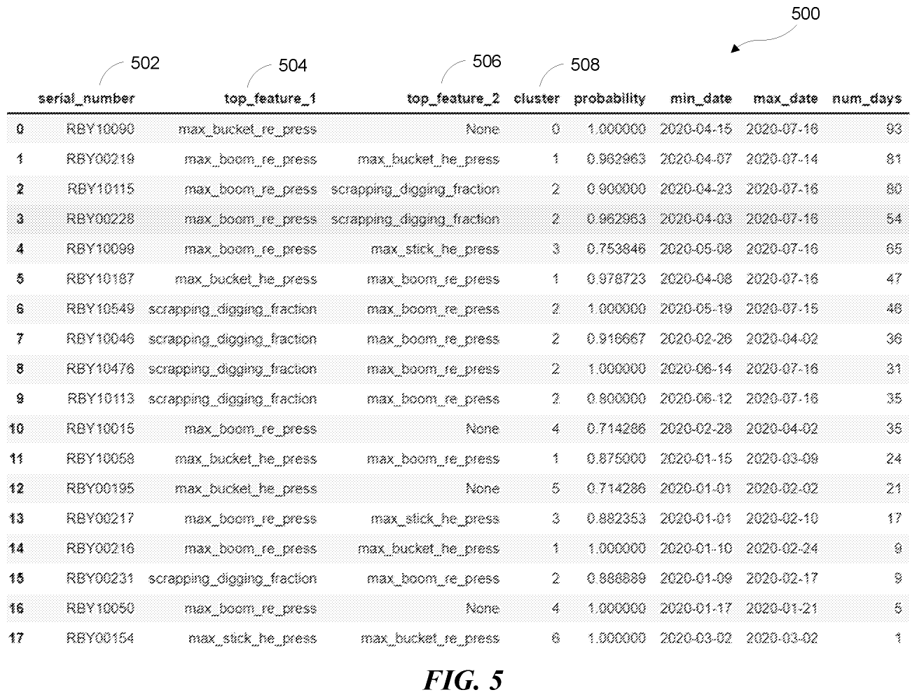

FIG. 5 is a table 500 illustrating grouping the anomalous machines 502 into groups or clusters 508. As disclosed above a difference between a mean value of each feature and a mean value of that feature for non-anomalous machines is calculated for each anomalous machine. The two top features 504 and 506 with the highest relative difference are selected and machines having the same top two features are grouped together. For example, all of the machines having top features of max_boom_re_press and scrapping_digging_fraction are grouped in the number 2 cluster 508.

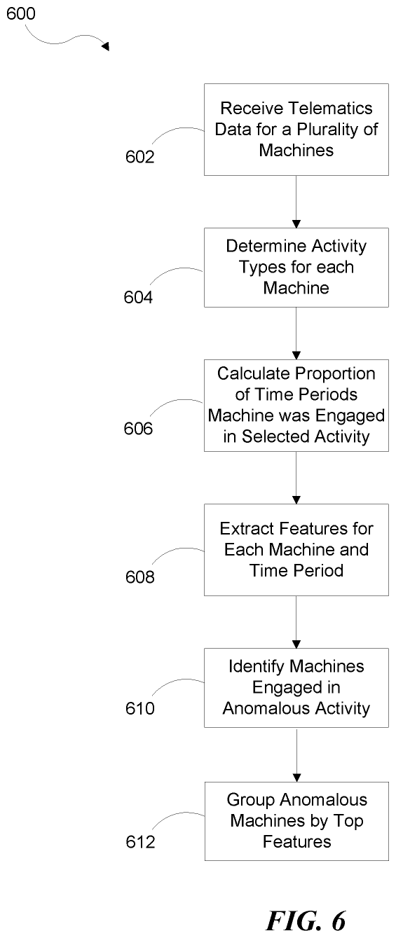

FIG. 6 is a flow diagram showing a method 600 for detecting machines engaged in anomalous activity according to some embodiments of the disclosed technology. The method 600 can include receiving telematics data from a plurality of sensors on each of a plurality of machines at step 602. At step 604, one or more activity types can be determined for each machine over a series of activity time periods (e.g., days) based on the associated telematics data for each machine. The method can also include calculating a proportion of the activity time periods in which each machine was engaged in one or more selected activities, such as digging and scrapping, at step 606. At step 608, one or more features are extracted for each machine for each of the series of activity time periods from the associated telematics data for each machine. In some embodiments, the one or more features includes a maximum hydraulic pressure for one or more cylinders on the machine. The method also includes identifying, at step 610, one or more of the plurality of machines engaged in anomalous activity based on at least the proportion and the one or more extracted features for the machines. In some embodiments, the method can include grouping anomalous machines by top features at step 612. Grouping the machines can include for each machine identified as engaged in anomalous activity, calculating a difference between a mean value of each feature and a mean value of that feature for non-anomalous machines, selecting the two top features with the highest relative difference, and grouping the machines with the same two top features.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

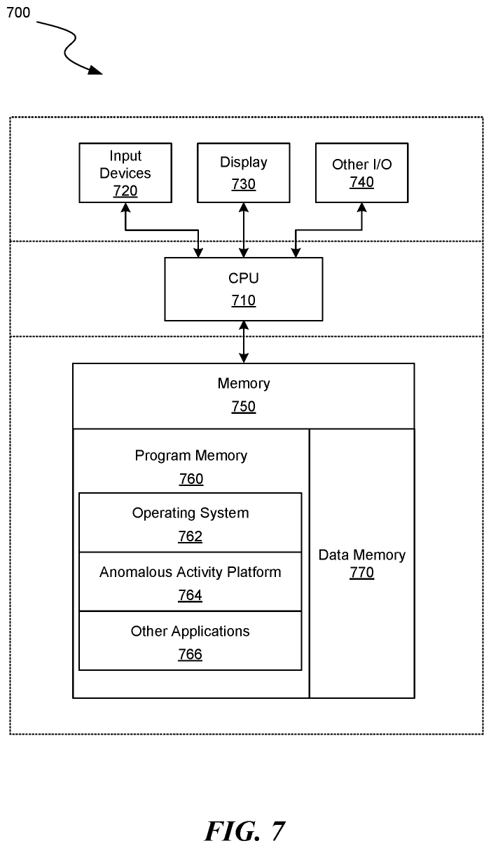

Several implementations are discussed below in more detail in reference to the figures. FIG. 7 is a block diagram illustrating an overview of devices on which some implementations of the disclosed technology can operate. The devices can comprise hardware components of a device 700 that detects machines engaged in anomalous activity, for example. Device 700 can include one or more input devices 720 that provide input to the CPU (processor) 710, notifying it of actions. The actions are typically mediated by a hardware controller that interprets the signals received from the input device and communicates the information to the CPU 710 using a communication protocol. Input devices 720 include, for example, sensors, a mouse, a keyboard, a touchscreen, an infrared sensor, a touchpad, a wearable input device, a camera- or image-based input device, a microphone, or other user input devices.

CPU 710 can be a single processing unit or multiple processing units in a device or distributed across multiple devices. CPU 710 can be coupled to other hardware devices, for example, with the use of a bus, such as a PCI bus or SCSI bus. The CPU 710 can communicate with a hardware controller for devices, such as for a display 730. Display 730 can be used to display text and graphics. In some examples, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 740 can also be coupled to the processor, such as a network card, video card, audio card, USB, FireWire or other external device, sensor, camera, printer, speakers, CD-ROM drive, DVD drive, disk drive, or Blu-Ray device.

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The CPU 710 can have access to a memory 750. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 750 can include program memory 760 that stores programs and software, such as an operating system 762, Anomalous Activity Detection Platform 764, and other application programs 766. Memory 750 can also include data memory 770 that can include database information, etc., which can be provided to the program memory 760 or any element of the device 700.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, programmable consumer electronics, network PCs, minicomputers, mainframe computers, IoT devices, on-board microcontrollers, edge computing devices, distributed computing environments and/or cloud platforms that include any of the above systems or devices, or the like.

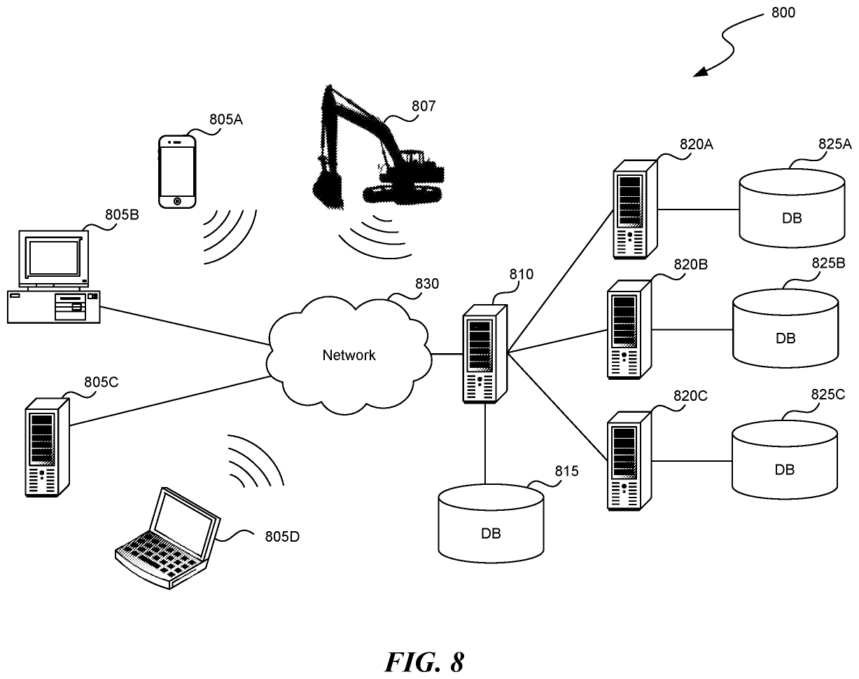

FIG. 8 is a block diagram illustrating an overview of an environment 800 in which some implementations of the disclosed technology can operate. Environment 800 can include one or more client computing devices 805A-D, examples of which can include device 700. Environment 800 can also include one or more machines 807. Client computing devices 805 and machines 807 can operate in a networked environment using logical connections through network 830 to one or more remote computers, such as a server computing device 810.

In some implementations, server computing device 810 can be an edge server that receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server computing device 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g., store) information. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

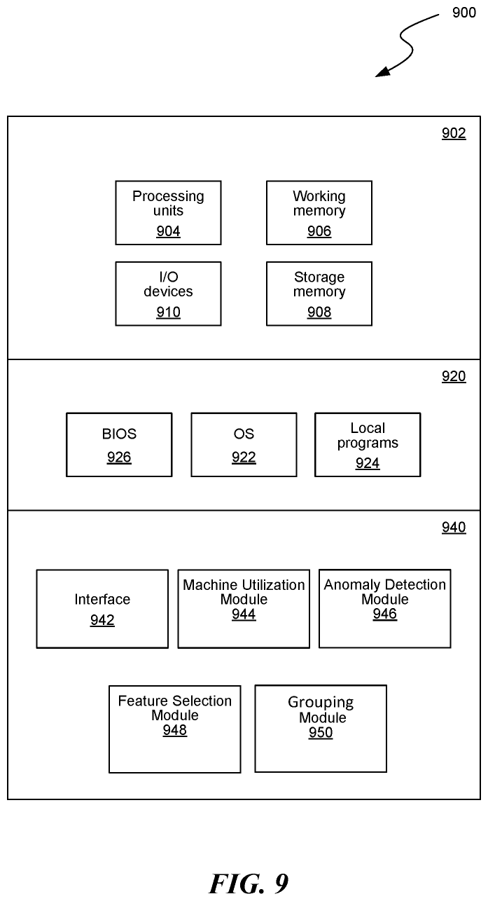

FIG. 9 is a block diagram illustrating components 900 which, in some implementations, can be used in a system employing the disclosed technology. The components 900 include hardware 902, general software 920, and specialized components 940. As discussed above, a system implementing the disclosed technology can use various hardware, including processing units 904 (e.g., CPUs, GPUs, APUs, etc.), working memory 906, storage memory 908, and input and output devices 910. Components 900 can be implemented in a client computing device such as client computing devices 805 or on a server computing device, such as server computing device 810 or 820.

General software 920 can include various applications, including an operating system 922, local programs 924, and a basic input output system (BIOS) 926. Specialized components 940 can be subcomponents of a general software application 920, such as local programs 924. Specialized components 940 can include a Machine Utilization Module 944, an Anomaly Detection Module 946, a Feature Selection Module 948, a Grouping Module 950, and components that can be used for transferring data and controlling the specialized components, such as Interface 942. In some implementations, components 900 can be in a computing system that is distributed across multiple computing devices or can be an interface to a server-based application executing one or more of specialized components 940.

Those skilled in the art will appreciate that the components illustrated in FIGS. 7-9 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, an anomalous activity detection system can include a Machine Utilization Module 944, an Anomaly Detection Module 946, a Feature Selection Module 948, and a Grouping Module 950 (FIG. 9). In operation, the Machine Utilization Module 944 can use telematics data from the sensors on excavators 20 and 30, such as from the boom cylinder pressure sensor 42, stick cylinder pressure sensor 44, and bucket cylinder pressure sensor 46, to estimate the machines' utilization patterns. The Feature Selection Module 948 can analyze the telematics data to identify features, e.g., boom cylinder pressure, that can be combined with the machine utilization pattern information to identify outlier days for each machine. The Anomaly Detection Module 946 uses principal component analysis to identify days in which the utilization pattern and selected features indicate outliers 310. Grouping Module 950 can group anomalous machines by top features. The top features are determined by calculating a difference between a mean value of each feature and a mean value of that feature for non-anomalous machines. The machines with the same top two features with the highest relative difference are grouped together to facilitate investigating the cause of the anomalous activity. In some embodiments, machines in the same group or cluster can be mapped to compare their geographic location. For example, anomalous machines confined to a relatively small geographic region could indicate that the machines are being used to perform a task that is not within the design parameters of the machine and/or has been modified such as with a ripper attachment.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method for detecting machines engaged in anomalous activity, the method comprising:
receiving telematics data from a plurality of sensors on each of a plurality of machines;
determining one or more activity types for each machine over a series of activity time periods based on the associated telematics data for each machine;
calculating a proportion of the activity time periods in which each machine was engaged in one or more selected activities;
extracting one or more features for each machine for each of the series of activity time periods from the associated telematics data for each machine; and
identifying one or more of the plurality of machines engaged in anomalous activity based on at least the proportion and the one or more extracted features for the machines.

2. The method of claim 1, wherein the one or more selected activities includes digging and scrapping.

3. The method of claim 1, wherein the one or more features includes a maximum hydraulic pressure for one or more cylinders on the machine.

4. The method of claim 1, wherein identifying the one or more of the plurality of machines engaged in anomalous activity includes analyzing the proportion and the one or more extracted features using principal component analysis to identify outlier activity time periods for each machine.

5. The method of claim 4, wherein identifying one or more of the plurality of machines engaged in anomalous activity includes identifying machines that have a percentage of outlier days exceeding a selected threshold.

6. The method of claim 5, further comprising, for each machine identified as engaged in anomalous activity, calculating a difference between a mean value of each feature and a mean value of that feature for non-anomalous machines, selecting the two top features with the highest relative difference, and grouping the machines with the same two top features.

7. A system for detecting machines engaged in anomalous activity, the system comprising:
one or more processors; and
one or more memory devices having stored thereon instructions that when executed by the one or more processors cause the one or more processors to:
receive telematics data from a plurality of sensors on each of a plurality of machines;
determine one or more activity types for each machine over a series of activity time periods based on the associated telematics data for each machine;
calculate a proportion of the activity time periods in which each machine was engaged in one or more selected activities;
extract one or more features for each machine for each of the series of activity time periods from the associated telematics data for each machine; and
identify one or more of the plurality of machines engaged in anomalous activity based on at least the proportion and the one or more extracted features for the machines.

8. The system of claim 7, wherein the one or more selected activities includes digging and scrapping.

9. The system of claim 7, wherein the one or more features includes a maximum hydraulic pressure for one or more cylinders.

10. The system of claim 7, wherein identifying the one or more of the plurality of machines engaged in anomalous activity includes analyzing the proportion and the one or more extracted features using principal component analysis to identify outlier activity time periods for each machine.

11. The system of claim 10, wherein identifying one or more of the plurality of machines engaged in anomalous activity includes identifying machines that have a percentage of outlier days exceeding a selected threshold.

12. The system of claim 11, further comprising, for each machine identified as engaged in anomalous activity, calculating a difference between a mean value of each feature and a mean value of that feature for non-anomalous machines, selecting the two top features with the highest relative difference, and grouping the machines with the same two top features.

13. The system of claim 7, wherein each of the series of activity time periods is a day.

14. One or more non-transitory computer-readable media storing computer-executable instructions that, when executed by one or more processors, cause the one or more processors to perform operations comprising:
receiving telematics data from a plurality of sensors on each of a plurality of machines;
determining one or more activity types for each machine over a series of activity time periods based on the associated telematics data for each machine;
calculating a proportion of the activity time periods in which each machine was engaged in one or more selected activities;
extracting one or more features for each machine for each of the series of activity time periods from the associated telematics data for each machine; and
identifying one or more of the plurality of machines engaged in anomalous activity based on at least the proportion and the one or more extracted features for the machines.

15. The non-transitory computer-readable media of claim 14, wherein the one or more selected activities includes digging and scrapping.

16. The non-transitory computer-readable media of claim 14, wherein the one or more features includes a maximum hydraulic pressure for one or more cylinders.

17. The non-transitory computer-readable media of claim 14, wherein identifying the one or more of the plurality of machines engaged in anomalous activity includes analyzing the proportion and the one or more extracted features using principal component analysis to identify outlier activity time periods for each machine.

18. The non-transitory computer-readable media of claim 17, wherein identifying one or more of the plurality of machines engaged in anomalous activity includes identifying machines that have a percentage of outlier days exceeding a selected threshold.

19. The non-transitory computer-readable media of claim 18, further comprising, for each machine identified as engaged in anomalous activity, calculating a difference between a mean value of each feature and a mean value of that feature for non-anomalous machines, selecting the two top features with the highest relative difference, and grouping the machines with the same two top features.
